(19) United States
(12) Patent Application Publication
(10) Pub. No.: US 2025/0372066 A1
(43) Pub. Date: Dec. 4, 2025

(54) INFORMATION PROCESSING METHOD AND ELECTRONIC KEYBOARD INSTRUMENT

(71) Applicant: Yamaha Corporation, Hamamatsu (JP)

(72) Inventor: Kazuhiko YAMAMOTO, Hamamatsu (JP)

(21) Appl. No.: 19/305,549

(22) Filed: Aug. 20, 2025

Related U.S. Application Data
(63) Continuation of application No. PCT/JP2024/002394, filed on Jan. 26, 2024.

(30) Foreign Application Priority Data
Feb. 21, 2023 (JP) 2023-025012

(51) Int. Cl. G10H 1/00

(52) U.S. Cl. CPC G10H 1/0016; G10H 2220/041; G10H 2250/311

(57) ABSTRACT

An information processing method is realized by a computer system, and includes acquiring input data including image data representing an image including at least a hand of a user playing a musical instrument, first finger position data representing a position of each of a plurality of analysis points on the hand, and performance data representing a performance of the musical instrument, and processing the input data using a trained generative model, thereby generating second finger position data in which the position of each of the plurality of analysis points in the first finger position data is corrected in accordance with a position of the hand represented by the image data and the performance represented by the performance data.

### CROSS-REFERENCE TO RELATED APPLICATIONS

This application is a continuation application of International Application No. PCT/JP2024/002394, filed on Jan. 26, 2024, which claims priority to Japanese Patent Application No. 2023-025012 filed in Japan on Feb. 21, 2023. The entire disclosures of International Application No. PCT/JP2024/002394 and Japanese Patent Application No. 2023-025012 are hereby incorporated herein by reference.

### BACKGROUND

### Technical Field

The present disclosure generally relates to a technique for analyzing a performance of a musical instrument.

### Background Information

Various techniques for analyzing a performance of a musical instrument by a user have been proposed in the prior art. For example, International Publication No. 2021/157691 discloses a feature in which an image containing the keyboard of a keyboard instrument and a user's hand is analyzed to estimate the shape of the user's hand.

### SUMMARY

However, in reality, it is difficult to estimate the shape of a hand with high accuracy simply by analyzing an image containing the keyboard of a keyboard instrument and a user's hand. For example, in a state in which a finger operating the keyboard is hidden behind another finger due to techniques such as finger crossing, or in a state in which a finger that is moving at a high speed is blurred in the image, it is not possible to estimate the shape of the user's hand with high accuracy by analyzing the image. In consideration of such circumstances, an object of one aspect of the present disclosure is to estimate, with high accuracy, the shape of a user's hand while playing a musical instrument.

In order to solve the problem described above, an information processing method according to one aspect of this disclosure comprises acquiring input data including image data representing an image including at least a hand of a user playing a musical instrument, first finger position data indicating the position of each of a plurality of analysis points on the hand, and performance data representing a performance of the musical instrument; and processing the input data using a trained generative model, thereby generating second finger position data in which the position of each of the plurality of analysis points in the first finger position data is corrected in accordance with the position of the hand represented by the image data and the performance represented by the performance data.

### BRIEF DESCRIPTION OF THE DRAWINGS

FIG. 1 is a block diagram of an information processing system according to a first embodiment.

FIG. 2 is an explanatory diagram of image data and region data.

FIG. 3 is a block diagram illustrating a functional configuration of the information processing device.

FIG. 4 is an explanatory diagram of analysis data.

FIG. 5 is a block diagram illustrating a configuration of an analysis processing unit.

FIG. 6 is a schematic diagram of finger position data.

FIG. 7 is a block diagram of an input data acquisition unit.

FIG. 8 is a flowchart of a supplementing process.

FIG. 9 is a flowchart of an analysis process.

FIG. 10 is an explanatory diagram of a training processing unit.

FIG. 11 is a flowchart of a training process.

FIG. 12 is a block diagram of an electronic keyboard instrument in a fourth embodiment.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

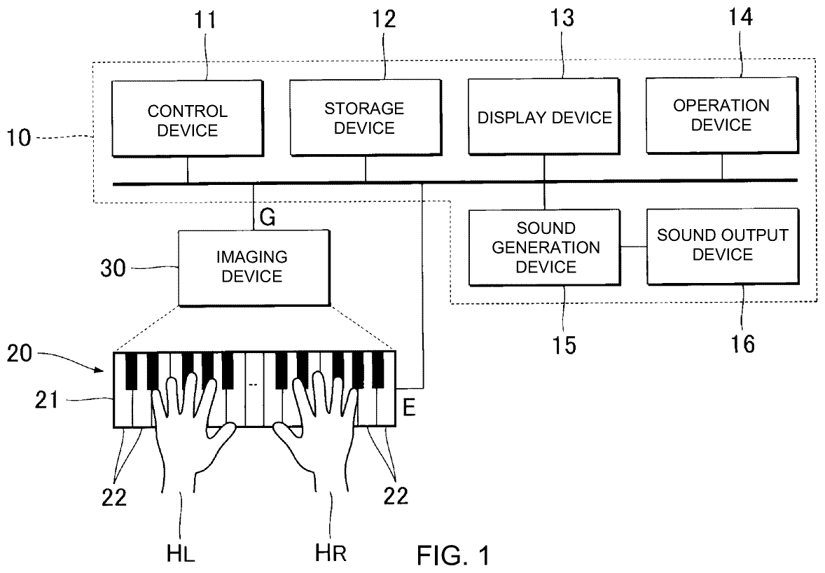

FIG. 1 is a block diagram illustrating a configuration of an information processing system 10 according to a first embodiment. The information processing system 10 is a computer system for analyzing a performance of an electronic instrument 20 by a user (that is, a performer). The electronic instrument 20 and an imaging device 30 are connected to the information processing system 10 by wire or wirelessly.

The electronic instrument 20 is an electronic keyboard instrument comprising a keyboard 21. The keyboard 21 comprises a plurality of keys 22 corresponding to different pitches. A user operates each of the keys 22 in sequence in order to play a desired musical piece.

The electronic instrument 20 transmits, to the information processing system 10, performance data E representing a performance by the user. The performance data E are data representing the pitches played by the user. The performance data E are sequentially transmitted from the electronic instrument 20 for each operation of each of the keys 22 by the user. For example, the performance data E specify the pitch corresponding to the key 22 operated by the user and the intensity of the key depression. The performance data E are event data conforming to the MIDI (Musical Instrument Digital Interface) standard, for example.

The imaging device 30 is an image input device that captures an image of the performance of the electronic instrument 20 by the user. Specifically, the imaging device 30 generates image data G for each unit time interval (frame) on a time axis. The unit time interval is a time interval of a prescribed length. A time series of the image data G constitutes video data. For example, the imaging device 30 comprises an optical system such as a photographic lens, an imaging element that receives incident light from the optical system, and a processing circuit that generates image data G corresponding to the amount of light received by the imaging element. In the first embodiment, a configuration in which the imaging device 30 is connected to the information processing system 10 as a separate body will be illustrated, but the imaging device 30 can be mounted on the information processing system 10.

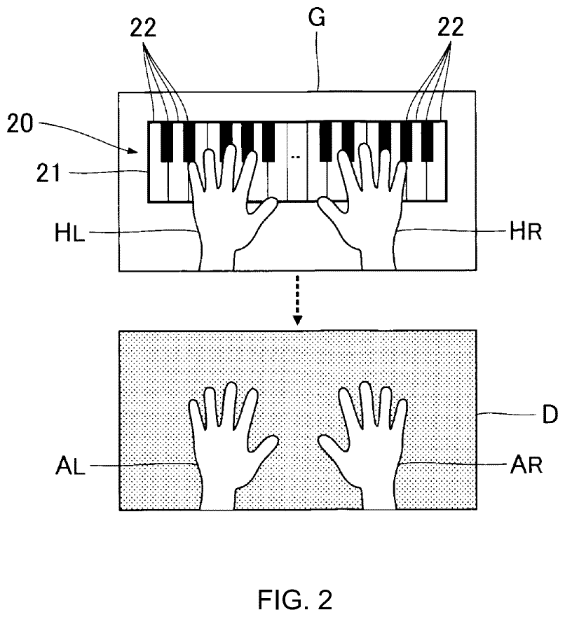

The imaging device 30 of the first embodiment is placed above the electronic instrument 20 and captures images of the keyboard 21 of the electronic instrument 20 and a user's right hand HR and left hand HL. Accordingly, as shown in FIG. 2, image data G of an image (hereinafter referred to as “captured image”) including the keyboard 21 of the electronic instrument 20 and the user's right hand HR and left hand HL are generated in chronological order by the imaging device 30. That is, the image data G are data representing an image (captured image) of the right hand HR and the left hand HL of the user playing the electronic instrument 20. Video data representing video in which the user plays the electronic instrument 20 are generated in parallel with the user's performance.

The information processing system 10 of FIG. 1 is a computer system that analyzes the performance of the electronic instrument 20 by the user. The information processing system 10 is realized by an information device such as a smartphone, a tablet terminal, or a personal computer. The information processing system 10 comprises a control device 11, a storage device 12, a display device 13, an operation device 14, a sound source device 15, and a sound output device 16. Note that the information processing system 10 can be realized as a single device, or as a plurality of devices which are separately configured.

The control device (electronic controller) 11 is one or a plurality of processors that control each element of the information processing system 10. Specifically, the control device 11 comprises one or more types of processors, such as a CPU (Central Processing Unit), a GPU (Graphics Processing Unit), an SPU (Sound Processing Unit), a DSP (Digital Signal Processor), an FPGA (Field Programmable Gate Array), an ASIC (Application Specific Integrated Circuit), and the like.

The storage device 12 comprises one or more memory units (computer memories) for storing a program that is executed by the control device 11 and various data that are used by the control device 11. A known storage medium, such as a magnetic storage medium or a semiconductor storage medium, or a combination of a plurality of various types of storage media can be used as the storage device 12. Note that, for example, a portable storage medium that is attached to/detached from the information processing system 10 or a storage medium (for example, cloud storage) that the control device 11 can access via a communication network can also be used as the storage device 12.

The display device (display) 13 displays images under the control of the control device 11. For example, various display panels such as a liquid-crystal display panel or an organic EL (electroluminescent) panel are employed as the display device 13. The operation device (user operable input) 14 is an instruction input device that receives instructions from a user. For example, an operator that is operated by the user, or a touch panel integrally configured with the display device 13, is used as the operation device 14. Note that the display device 13 or the operation device 14 that is separate from the information processing system 10 can be connected to the information processing system 10 wirelessly or by wire.

The sound generation device (sound generator) 15 generates an audio signal corresponding to the performance data E. Specifically, the sound generation device 15 generates an audio signal representing a waveform of a musical sound represented by the performance data E. Note that the control device 11 can execute a program to realize the function of the sound generation device 15. The sound output device 16 emits the musical sound represented by the audio signal. For example, a speaker or headphones are used as the sound output device 16. Note that the sound output device 16 that is separate from the information processing system 10 can be connected to the information processing system 10 wirelessly or by wire.

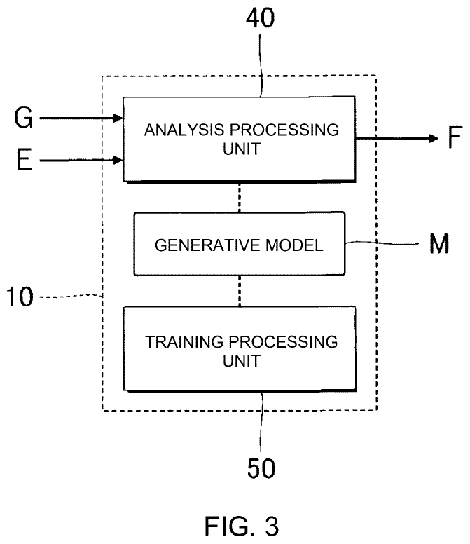

FIG. 3 is a block diagram illustrating a functional configuration of the information processing device 10. The control device 11 executes a program that is stored in the storage device 12 to realize a plurality of functions (analysis processing unit 40 and training processing unit 50) for analyzing the performance of the electronic instrument 20 by the user.

### Analysis Processing Unit 40

The analysis processing unit 40 processes the image data G supplied from the imaging device 30 and the performance data E supplied from the electronic instrument 20 to generate analysis data F. The analysis data F are data representing the result of analyzing the performance of the electronic instrument 20 by the user. Specifically, the analysis data F are data representing the states of the right hand HR and the left hand HL of the user during the performance. The analysis data F are sequentially generated in parallel with the user's performance. Specifically, the analysis processing unit 40 generates the analysis data F for each unit time interval.

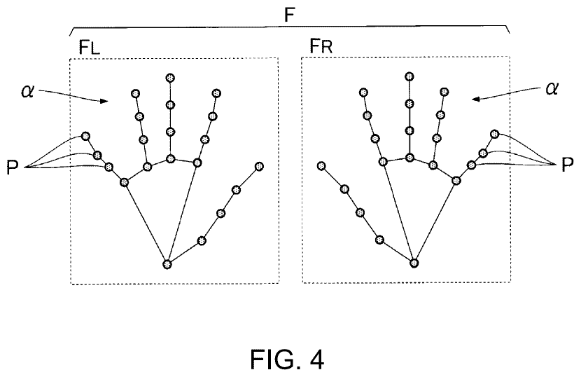

FIG. 4 is an explanatory diagram of the analysis data F. The analysis data F include analysis data FR and analysis data FL. The analysis data FR are data representing coordinates of each of a plurality of analysis points P corresponding to the user's right hand HR. The analysis data FL are data representing coordinates of each of a plurality of analysis points P corresponding to the user's left hand HL.

The analysis points P are points to be analyzed on the right hand HR and the left hand HL of the user. Specifically, the tip of each finger, the points of each joint, and the point corresponding to the wrist of the user are exemplified as the analysis points P. Each of the analysis points P is set in space α. The space α is a three-dimensional space set for each of the right hand HR and the left hand HL. For example, the space α is set using an analysis point P corresponding to the user's wrist as a reference (for example, the origin). As can be understood from the foregoing explanation, the analysis data F are data representing the posture of the user's hands during a performance.

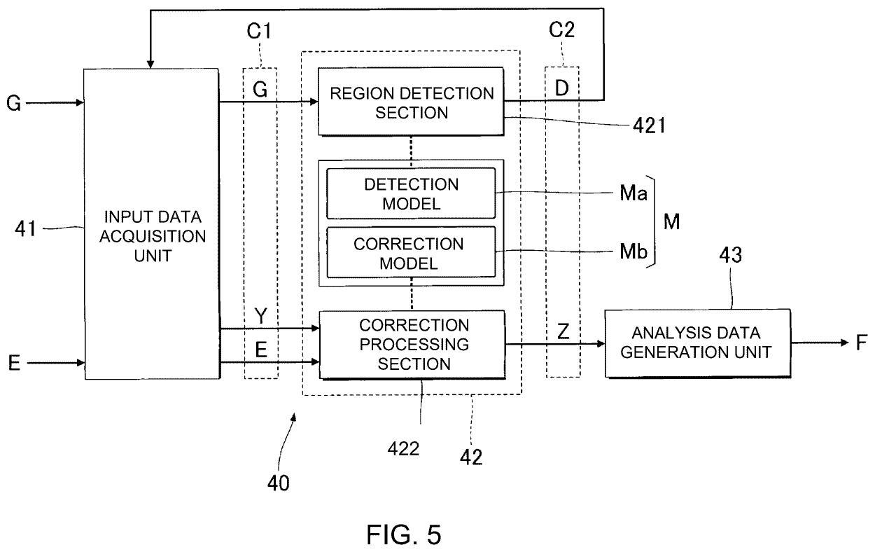

FIG. 5 is a block diagram illustrating a configuration of the analysis processing unit 40. The analysis processing unit 40 comprises an input data acquisition unit 41, a finger position data generation unit 42, and an analysis data generation unit 43. The input data acquisition unit 41 acquires input data C1 for each unit time interval. The input data C1 of each unit time interval include the image data G, the performance data E, and finger position data Y. The finger position data Y are data representing the position of each of the plurality of analysis points P on the right hand HR and the left hand HL of the user.

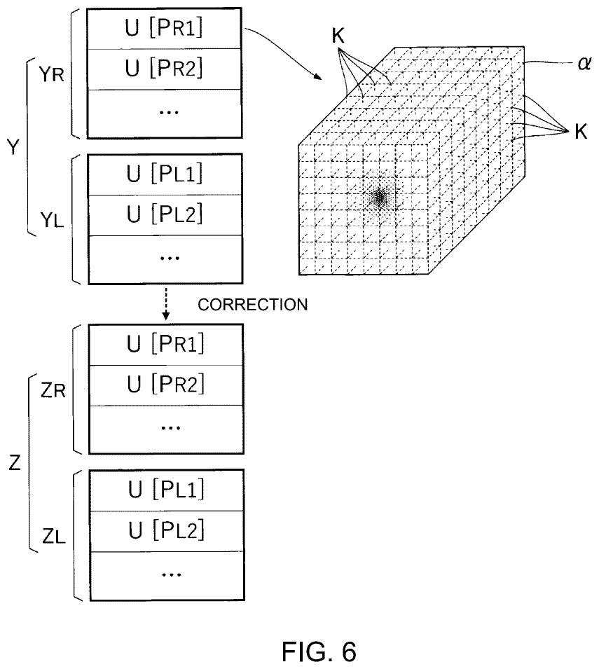

FIG. 6 is a schematic diagram of the finger position data Y. The finger position data Y include finger position data YR corresponding to the user's right hand HR and finger position data YL corresponding to the user's left hand HL. The finger position data YR include a plurality of pieces of unit data (first unit data) U corresponding to different analysis points P (PR1, PR2, . . . ) on the user's right hand HR. The finger position data YL include a plurality of pieces of unit data (first unit data) U corresponding to different analysis points P (PL1, PL2, . . . ) on the user's left hand HL.

The unit data (first unit data) U corresponding to one analysis point P are data representing the probability distribution of the analysis point P in the space. As shown in FIG. 6, a plurality of lattice points K are set in the space α. Each of the lattice points K is a point (grid) set at equal intervals in each direction of three mutually orthogonal axes in the space α. The unit data U represent the probability Q for each of the plurality of lattice points K in the space α. The probability Q of each of the lattice points K is the probability that said lattice point K corresponds to an analysis point P. For example, the higher the probability Q of one of the lattice points K in the space α, the higher the probability that said lattice point K corresponds to an analysis point P. Accordingly, the distribution of a plurality of probabilities Q represented by the unit data U corresponds to the probability distribution of the analysis point P in the space α. That is, the finger position data YR represent the probability distribution, in the space α, of each of the plurality of analysis points P corresponding to the user's right hand HR. Similarly, the finger position data YL represent the probability distribution, in the space α, of each of the plurality of analysis points P corresponding to the user's left hand HL.

The finger position data generation unit 42 of FIG. 5 processes the input data C1 to generate output data C2. The output data C2 are generated for each unit time interval in parallel with the user's performance. The output data C2 include region data D and finger position data Z.

As shown in FIG. 2, the region data D are data representing a right-hand region AR and a left-hand region AL within the captured image represented by the image data G. The right-hand region AR is a region in the captured image in which the user's right hand HR exists. The left-hand region AL is a region in the captured image in which the user's left hand HL exists. The region data D are used for the generation of the finger position data Y by the input data acquisition unit 41, as will be described further below.

Similar to finger position data Y, finger position data Z are data representing the position of each of the plurality of analysis points P on the user's right hand HR and left hand HL. Specifically, the finger position data Z are data in which the position of each of the analysis points P in the finger position data Y has been corrected in accordance with the positions of the right hand HR and the left hand HL indicated by the image data G and the performance represented by the performance data E.

As shown in FIG. 6, the format of the finger position data Z is the same as that of the finger position data Y. Specifically, the finger position data Z include finger position data ZR corresponding to the user's right hand HR and finger position data ZL corresponding to the user's left hand HL. The finger position data ZR include a plurality of pieces of unit data (second unit data) U corresponding to different analysis points P (PR1, PR2, . . . ) on the user's right hand HR. The finger position data ZL include a plurality of pieces of unit data (second unit data) U corresponding to different analysis points P (PL1, PL2, . . . ) on the user's left hand HL. The unit data (second unit data) U of each of the analysis points P represent the probability distribution of said analysis point P in the space α. The finger position data Y are an example of “first finger position data” and the finger position data Z are an example of “second finger position data.”

As shown in FIG. 5, a generative model M is used for the generation of the output data C2 by the finger position data generation unit 42. The generative model M is a trained model M in which the relationship between the input data C1 and the output data C2 has been learned through machine learning. The generative model M can also be expressed as a trained model M in which the relationship between the input data C1 and the output data C2 is acquired through training (machine learning). The finger position data generation unit 42 processes the input data C1 of each unit time interval using the generative model M to generate the output data C2. That is, the finger position data generation unit 42 inputs the input data C1 to the generative model M to generate the output data C2.

The generative model M comprises a deep neural network (DNN), for example. Any type of deep neural network, such as a recurrent neural network (RNN) or a convolutional neural network (CNN), can be used as the generative model M. The generative model M can comprise a combination of a plurality of types of deep neural networks. In addition, an additional element such as long short term memory (LSTM) or attention can be incorporated into the generative model M.

The finger position data generation unit 42 includes a region detection section 421 and a correction processing section 422. The generative model M includes a detection model Ma and a correction model Mb. Each of the detection model Ma and the correction model Mb is realized by a combination of a program that causes the control device 11 to execute a prescribed computation, and a plurality of variables (specifically, weights and biases) that are applied to said computation. The program and the plurality of variables that realize the detection model Ma and the correction model Mb are stored in the storage device 12. The plurality of variables are set in advance by machine learning.

The detection model Ma outputs region data D in response to an input of image data G. That is, the detection model Ma is a trained model for object detection (semantic segmentation) that extracts the right-hand region AR and the left-hand region AL from a captured image represented by the image data G. The detection model Ma can be expressed as a trained model in which the relationship between the image data G and the region data D has been learned. For example, a U-Net type model constituted by an encoder and a decoder is exemplified as a detection model Ma. The region detection section 421 processes the image data G using the detection model Ma to generate the region data D.

The correction model Mb outputs the finger position data Z in response to an input of the finger position data Y and the performance data E. That is, the correction model Mb is a trained model that has learned the relationship between the finger position data Z and a set of the finger position data Y and the performance data E. For example, an autoencoder constituted by an encoder and a decoder is exemplified as the correction model Mb. The correction processing section 422 processes the finger position data Y and the performance data E using the correction model Mb to generate the finger position data Z. Intermediate data generated by the detection model Ma in the process of generating the region data D can be input to the correction model Mb together with the finger position data Y and the performance data E. The intermediate data input to the correction model Mb are data output by the encoder of the first half portion of the detection model Ma, for example.

The analysis data generation unit 43 in FIG. 5 generates analysis data F from the finger position data Z generated by the finger position data generation unit 42 (correction processing section 422). Specifically, the analysis data generation unit 43 generates analysis data FR from the finger position data ZR of the right hand HR from among the finger position data Z, and generates analysis data FL from the finger position data ZL of the left hand HL from among the finger position data Z.

For example, the analysis data generation unit 43 determines, as the analysis point P of the right hand HR, a point (for example, a lattice point K) where the probability Q becomes maximum in the probability distribution represented by each piece of unit data U of the finger position data ZR. The analysis data generation unit 43 executes the foregoing process for each piece of unit data U of the finger position data ZR to generate the analysis data FR representing the coordinates of each of the analysis points P of the right hand HR. Similarly, the analysis data generation unit 43 determines, as the analysis point P of the left hand HL, a point (for example, a lattice point K) where the probability Q becomes maximum in the probability distribution represented by each piece of unit data U of the finger position data ZL. The analysis data generation unit 43 executes the foregoing process for each piece of unit data U of the finger position data ZL to generate the analysis data FL representing the coordinates of each of the analysis points P of the left hand HL. Each of the analysis points P of the right hand HR and the left hand HL represented by the analysis data F is displayed on the display device 13 as an analysis result.

The process by which the analysis data generation unit 43 generates the analysis data F from the finger position data Z is not limited to the example described above. For example, the analysis data generation unit 43 can determine each of the analysis points P under a constraint condition relating to the positional relationship of each of the analysis points P, or a constraint condition relating to the movement speed of each of the analysis points P. The constraint condition relating to the positional relationship is a condition in which the distance between two adjacent analysis points P on one finger does not change, for example. In addition, the constraint condition relating to the movement speed is a condition in which the movement speed of each of the analysis points P is lower than a prescribed value.

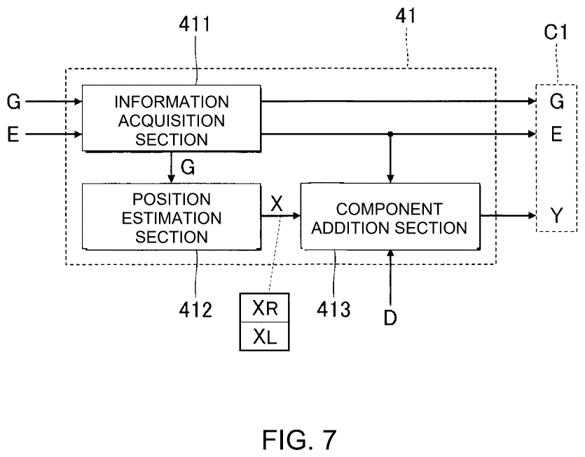

FIG. 7 is a block diagram illustrating the configuration of the input data acquisition unit 41. The input data acquisition unit 41 comprises an information acquisition section 411, a position estimation section 412, and a component addition section 413. The information acquisition section 411 receives the image data G sequentially supplied from the imaging device 30 and the performance data E sequentially supplied from the electronic instrument 20. The position estimation section 412 and the component addition section 413 generate the above-mentioned finger position data Y for each unit time interval. As can be understood from the foregoing explanation, the “acquisition” of data by the input data acquisition unit 41 encompasses “reception” and “generation.”

The position estimation section 412 of FIG. 7 generates finger position data X from the image data G. Similar to the finger position data Y, finger position data X are data representing the position of each of a plurality of analysis points P on the user's right hand HR and left hand HL. The finger position data X are an example of “initial data.”

The format of the finger position data X is the same as that of the finger position data Y. Specifically, the finger position data X include finger position data XR corresponding to the user's right hand HR and finger position data XL corresponding to the user's left hand HL. The finger position data XR include a plurality of pieces of unit data U corresponding to different analysis points P on the user's right hand HR. The finger position data XL include a plurality of pieces of unit data U corresponding to different analysis points P on the user's left hand HL. The unit data U of each of the analysis points P represent the probability distribution of said analysis point P in the space x. Any known technique can be employed for the generation of the finger position data Y.

There are cases in which the user's hand is partially unclear in the captured image represented by the image data G. For example, a portion of the user's hand that is moving fast can become an unclear image due to blur. In addition, a portion of the user's hand that is hidden behind another finger can become an unclear image. As described above, the probability distribution in the space α for an analysis point P corresponding to an unclear portion in the captured image is not specified. Accordingly, there are cases in which the unit data U of the finger position data X become a null value. A “null value” for the unit data U is a situation in which the unit data U do not include a significant numerical value for any of the plurality of lattice points K in the space α. An example of a “null value” is a state in which the probability Q of all of the lattice points K in the unit data U is zero.

The component addition section 413 of FIG. 7 generates the finger position data Y from the finger position data X. Specifically, the component addition section 413 executes a supplementing process with respect to each piece of null unit data U (hereinafter referred to as “null data U0”) from among the plurality of pieces of unit data U of the finger position data X, thereby generating the finger position data Y. A supplementing process is a process in which an auxiliary component (hereinafter referred to as “auxiliary component R”) is added to each piece of null data U0 of the finger position data X. The region data D and the performance data E are used for the supplementing process.

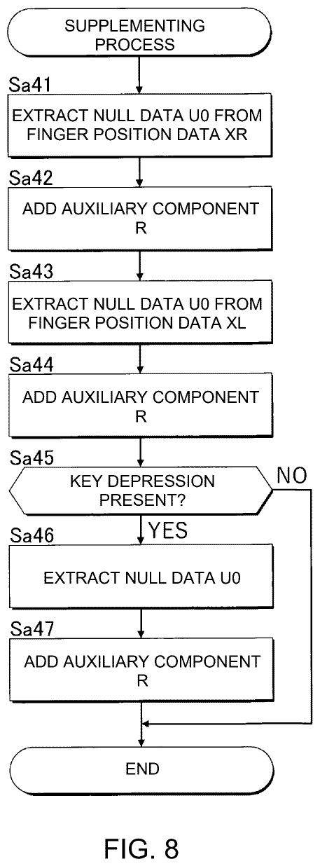

FIG. 8 is a flowchart of the supplementing process. The supplementing process is executed for each unit time interval. The control unit 11 executes the supplementing process of FIG. 8, thereby realizing the component addition section 413.

When the supplementing process is started, the control device 11 extracts one or more pieces of null data U0 from the plurality of pieces of unit data U of the finger position data XR (Sa41). The control device 11 adds an auxiliary component R to the probability Q (=0) corresponding to each lattice point K in the right-hand region AR, from among the plurality of probabilities Q specified by each piece of null data U0 (Sa42). The auxiliary component R is a prescribed positive number less than one. Since the user's right hand HR exists in the right-hand region AR, a probability distribution should inherently exist. If the unit data U are null despite the circumstance described above, it is likely that a probability distribution was not appropriately estimated because the captured image is unclear. The addition of the auxiliary component R is a process that compensates for lacks in the probability distribution described above. During a unit time interval in which the right-hand region AR is not detected, addition of the auxiliary component R (Sa41, Sa42) is not executed.

A similar process is also executed for the finger position data XL corresponding to the left hand HL. That is, the control device 11 extracts one or more pieces of null data U0 from the plurality of pieces of unit data U of the finger position data XL (Sa43). The control device 11 adds an auxiliary component R to the probability Q (=0) corresponding to each lattice point K in the left-hand region AL, from among the plurality of probabilities Q specified by each piece of null data U0 (Sa44). During a unit time interval in which the left-hand region AL is not detected, addition of the auxiliary component R (Sa43, Sa44) is not executed.

When the process described above is executed, the control device 11 determines whether the performance data E indicate a key depression (Sa45). When the performance data E indicate a key depression (Sa45: YES), the control device 11 extracts one or more pieces of null data U0 from the plurality of pieces of unit data U included in the finger position data X (XR, XL) (Sa46). The control device 11 adds an auxiliary component R to the probability Q corresponding to each lattice point K in the vicinity of the key 22 that is being depressed, from among the plurality of probabilities Q specified by each piece of null data U0 (Sa47). For example, a normal distribution centered on a point in the space α corresponding to the key 22 being depressed is added as the auxiliary component R.

As can be understood from the foregoing explanation, when the performance data E indicate a key depression, or when the user's hand is detected in the region data D, the component addition section 413 adds the auxiliary component R to the finger position data X to generate the finger position data Y. When the performance data E do not indicate a key depression and the user's hand is not detected in the region data D, the finger position data X are determined as the finger position data Y as is.

The specific procedure of the supplementing process is as described above. The correction processing section 422 of the finger position data generation unit 42 processes, using the correction model Mb, the finger position data Y generated by the supplementing process and the performance data E acquired by the information acquisition section 411 to generate the finger position data Z. The generative model M (correction model Mb) is constructed by machine learning in advance so as to output the finger position data Z in which the position of each of the analysis points P in the finger position data Y has been corrected in accordance with the positions of the hands indicated by the image data G and the performance represented by the performance data E. For example, as a result of the position of each of the analysis points P being corrected, unit data U (null data U0) that were null in the finger position data Y are changed to unit data U including a significant numerical value, which is numerical value that is not zero, in the finger position data Z. The unit data U including the significant numerical value(s) are unit data in which the probability Q of at least one or more of the lattice points K has a value that is not zero. That is, the number (for example, zero) of pieces of null data U0 in the finger position data Z is smaller than the number of pieces of null data U0 in the finger position data Y.

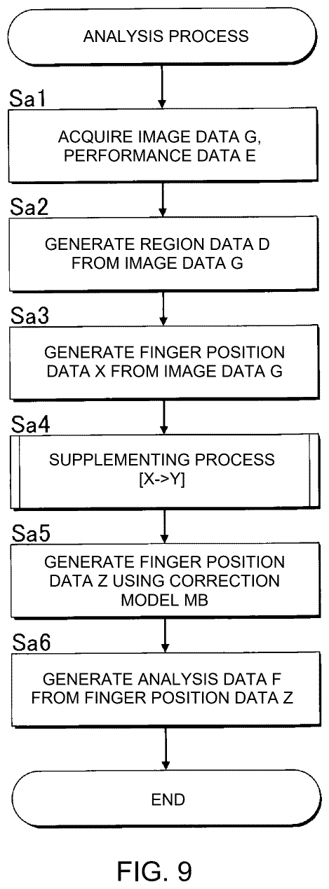

FIG. 9 is a flowchart of a process (hereinafter referred to as “analysis process”) by which the control device 11 generates the analysis data F. The analysis process of FIG. 9 is executed for each unit time interval. When the analysis process is started, the control device 11 (information acquisition section 411) acquires the image data G and the performance data E (Sal). The control device 11 (region detection section 421) processes the image data G using the detection model Ma to generate the region data D (Sa2).

The control device 11 (position estimation section 412) analyzes the image data G to generate the finger position data X (Sa3). The control device 11 (component addition section 413) executes, on the finger position data X, the above-mentioned supplementing process using the region data D and the performance data E to generate the finger position data Y (Sa4).

The control device 11 (correction processing section 422) processes the finger position data Y and the performance data E using the correction model Mb to generate the finger position data Z (Sa5). The control device 11 (analysis data generation unit 43) generates the analysis data F from the finger position data Z (Sa6).

As described above, in the first embodiment, the position of each of the analysis points P in the finger position data Y is corrected in accordance with the position of the hands indicated by the image data G and the performance represented by the performance data E, thereby generating the finger position data Z. That is, even if an analysis point P is missing in the finger position data X due to an unclear captured image, said analysis point P is supplemented by using the image data G and the performance data E. Specifically, it is possible to generate the finger position data Z (and the analysis data F) that are accurately expressed even for analysis points P in unclear portions of the captured image. Accordingly, it is possible to generate the finger position data Z (and the analysis data F) that are accurately expressed even for analysis points P in unclear portions of the captured image. That is, it is possible to estimate, with high accuracy, the shape of the user's hand while playing the electronic instrument 20.

As described above, according to the first embodiment, the shape of the user's hand while playing the electronic instrument 20 is estimated with high accuracy. Accordingly, the user can enjoy various customer experiences, such as products or services that use the estimation result.

In particular, in the first embodiment, the finger position data Y and the finger position data Z include the unit data U representing the probability distribution of each of the analysis points P. Accordingly, there is the benefit that training data T to be used for machine learning can be easily generated by adding the auxiliary component R to the finger position data Z generated by the generative model M in the training stage for establishing the generative model M.

### Training Processing Unit 50

The training processing unit 50 of FIG. 3 constructs the correction model Mb by machine learning. The detection model Ma is trained prior to the construction of the correction model Mb.

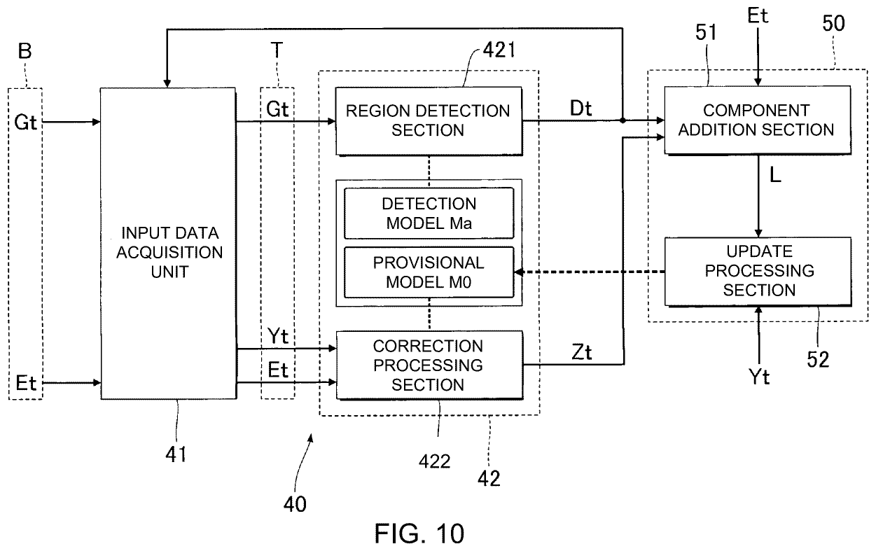

FIG. 10 is an explanatory diagram of the training processing unit 50. A plurality of pieces of basic data B are used for the machine learning of the correction model Mb. The plurality of pieces of basic data B are prepared in advance and stored in the storage device 12. Each piece of the basic data B include image data Gt for training and performance data Et for training. The performance of the electronic instrument 20 by a particular performer is recorded to thereby prepare the image data Gt and the performance data Et in advance. That is, the performance represented by the image data Gt and the performance represented by the performance data Et are the same.

In the machine learning of the correction model Mb, the input data acquisition unit 41 generates the training data T that include the image data Gt, the performance data Et, and finger position data Yt. The training data T correspond to the above-mentioned input data C1. Specifically, the finger position data Yt of the training data T are generated by executing the above-mentioned supplementing process on the finger position data Xt generated from the image data Gt.

The finger position data generation unit 42 processes the training data T to generate region data Dt and finger position data Zt. Specifically, the region detection section 421 processes the image data Gt using the detection model Ma to generate the region data Dt. The correction processing section 422 processes the finger position data Yt and the performance data Et using the initial or a provisional correction model Mb (hereinafter referred to as “provisional model M0”) to generate the finger position data Zt.

As illustrated in FIG. 10, the training processing unit 50 comprises a component addition section 51 and an update processing section 52. The component addition section 51 executes the above-mentioned supplementing process on the finger position data Zt to generate reference data L. Specifically, when the performance data Et represent a key depression, or when the user's hand is detected in the region data Dt, the component addition section 51 adds the auxiliary component R to the finger position data Zt to generate the reference data L.

The update processing section 52 updates the provisional model MO so as to reduce the difference between the finger position data Yt and the reference data L. Specifically, the update processing section 52 calculates an error function representing the difference between the finger position data Yt and the reference data L, and updates a plurality of variables of the provisional model MO such that the error function is reduced.

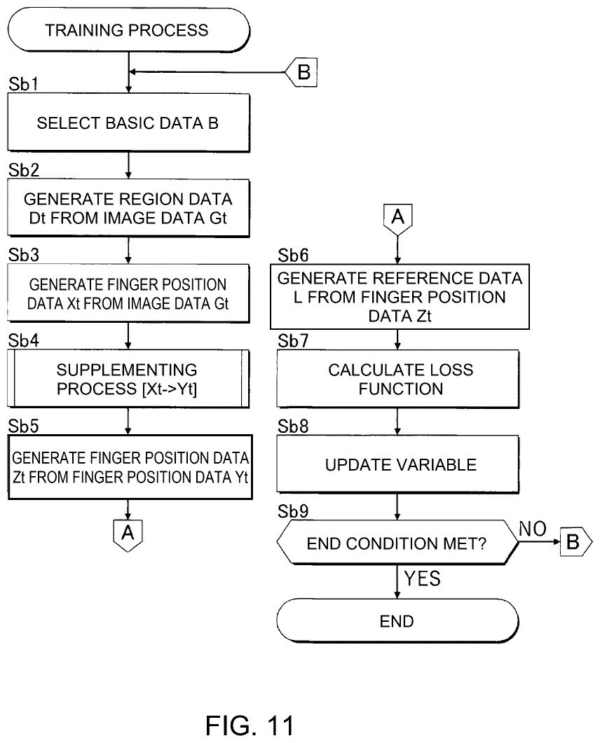

FIG. 11 is a flowchart of a process (hereinafter referred to as “training process”) by which the control device 11 updates the provisional model M0. For example, the training process is started triggered by an operation on the operation device 14.

When the training process is started, the control device 11 (training processing unit 50) selects any one of a plurality of pieces of basic data B (hereinafter referred to as “selected basic data B”) (Sb1). The control device 11 (region detection section 421) processes the image data Gt of the selected basic data B using the detection model Ma to generate the region data Dt (Sb2).

The control device 11 (position estimation section 412) analyzes the image data Gt of the selected basic data B to generate the finger position data Xt (Sb3). The control device 11 (component addition section 413) executes, on the finger position data Xt, the above-mentioned supplementing process using the region data Dt and the performance data Et to generate the finger position data Yt (Sb4). That is, the training data T including the image data Gt, the performance data Et, and the finger position data Yt are generated. The control device 11 (correction processing section 422) processes the finger position data Yt and the performance data Et using the provisional model M0 to generate the finger position data Zt (Sb5).

The control device 11 (component addition section 51) executes, on the finger position data Zt, the above-mentioned supplementing process using the region data Dt and the performance data Et to generate the reference data L (Sb6). The control device 11 (update processing section 52) calculates a loss function representing the error between the finger position data Yt and the reference data L (Sb7). The control device 11 (update processing section 52) updates a plurality of variables of the provisional model M0 such that the loss function is reduced (ideally minimized) (Sb8). For example, the backpropagation method is used to update each variable in accordance with the loss function.

The control device 11 determines whether a prescribed end condition has been met (Sb9). The end condition is that the loss function falls below a prescribed threshold value, or, that the amount of change in the loss function falls below a prescribed threshold value. If the end condition is not satisfied (Sb9: NO), the control device 11 selects unselected basic data B as the new selected basic data B (Sb1). That is, the process (Sb2-Sb8) of updating the plurality of variables of the provisional model M0 is repeated until the end condition is satisfied (Sb9: YES). If the end condition is satisfied (Sb9: YES), the control device 11 ends the training process. The provisional model M0 at the time that the end condition is satisfied is set as the trained correction model Mb.

The correction model Mb constructed by the training process described above is able to generate the finger position data Z in which the position of each of the analysis points P in the finger position data Y has been corrected in accordance with the image data G and the performance data E. Specifically, even if an analysis point P is missing in the finger position data X due to an unclear captured image, said analysis point P is supplemented by using the image data G and the performance data E. That is, a correction model Mb that can appropriately supplement the analysis points P is constructed by the training process. Accordingly, it is possible to generate the finger position data Z (and the analysis data F) that are accurately expressed even for analysis points P in unclear portions of the captured image.

### B: Second Embodiment

The second embodiment will be described. In each of the embodiments illustrated below, elements that have the same functions as those in first embodiment have been assigned the same reference symbols used to describe the first embodiment and detailed descriptions thereof have been appropriately omitted.

The region data D of the first embodiment are data representing the right-hand region AR and the left-hand region AL of a captured image. The region data D of the second embodiment are depth data indicating the depth of the surface of a user's hands (right hand HR and left hand HL) in a captured image. Regions in which the depth indicated by the depth data exceeds a threshold are identified as the right-hand region AR or the left-hand region AL. That is, the region data D of the second embodiment are data representing the right-hand region AR and the left-hand region AL, in the same manner as in the first embodiment. The region data Dt used for the training process are similarly depth data.

When the user's hand is detected in the region data D, the component addition section 413 adds the auxiliary component R to the finger position data X to generate the finger position data Y, in the same manner as in the first embodiment. When the user's hand is detected in the region data Dt, the component addition section 51 also adds the auxiliary component R to the finger position data Zt to generate the reference data L, in the same manner as in the first embodiment.

Other than the region data D and the region data Dt being depth data, the embodiment is the same as the first embodiment. Therefore, the same effects as those of the first embodiment can be realized by the second embodiment. In addition, in the second embodiment, depth data indicating the depth of the surface of the hand represented by the image data G are generated as the region data D. Accordingly, for example, even if the user's hand is unclear in the captured image represented by the image data G, it is possible to estimate, with high accuracy, the shape of the user's hand while playing the electronic instrument 20.

### C: Third Embodiment

In the first embodiment, the auxiliary component R is added to the finger position data X when the user's hand is detected in the region data D. In the third embodiment, the auxiliary component R is added to the finger position data X when a hand detected in the region data D overlaps with the keyboard 21.

The region detection section 421 generates the region data D indicating the region of the keyboard 21 (hereinafter referred to as “keyboard region”) in addition to the right-hand region AR and the left-hand region AL. For example, the detection model Ma is used for the detection of the keyboard region. The region detection section 421 can detect the keyboard region in accordance with the user's operation of the keyboard 21. For example, the user operates a first key 22 located near the left end (end on the low note side) of the keyboard 21 and a second key 22 located near the right end (end on the high note side). The region detection section 421 identifies the first key 22 and the second key 22 from the image data G and identifies the region between the first key 22 and the second key 22 as the keyboard region.

When the right-hand region AR or the left-hand region AL overlaps with the keyboard region in the region data D, the component addition section 413 adds the auxiliary component R to the finger position data X to generate the finger position data Y. Similarly, when the right-hand region AR or the left-hand region AL overlaps with the keyboard region in the region data D, the component addition section 51 also adds the auxiliary component R to the finger position data Zt to generate the reference data L.

The same effects as those of the first embodiment are realized in the third embodiment. In addition, in the third embodiment, when the user's hand overlaps with the keyboard 21, the addition of the auxiliary component R is executed. That is, not only whether the user's hand is detected but also the relationship between the keyboard 21 and the hand is taken into consideration when adding the auxiliary component R. Accordingly, it is possible to estimate, with high accuracy, the shape of the user's hand while playing the electronic instrument 20.

### D: Fourth Embodiment

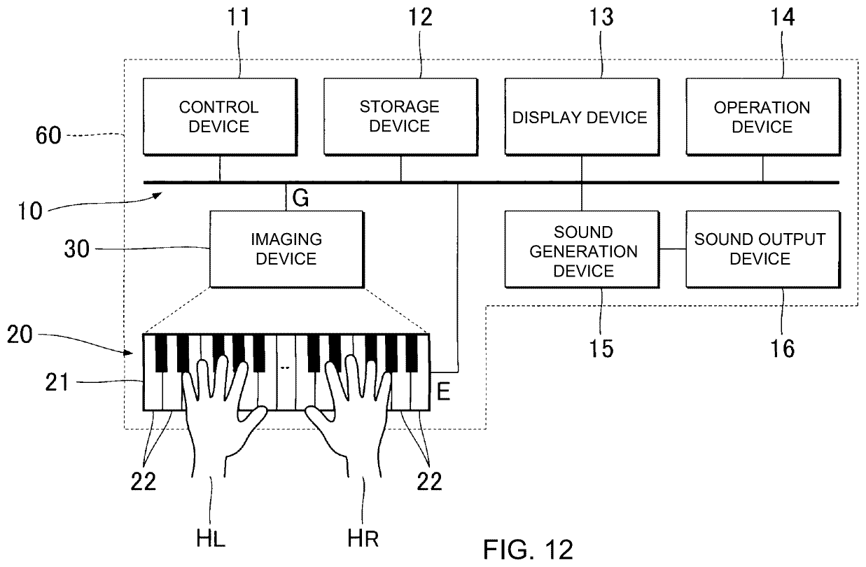

FIG. 12 is a block diagram showing a configuration of an electronic keyboard instrument 60 according to a fourth embodiment. In the first embodiment, a configuration was shown in which the information processing system 10, the electronic instrument 20, and the imaging device 30 are configured as separate bodies. The electronic keyboard instrument 60 of the fourth embodiment is an electronic instrument in which the information processing system 10, the electronic instrument 20, and the imaging device 30 are installed in a single housing (not shown). However, the imaging device 30 that is separate from the electronic keyboard instrument 60 can be connected to the electronic keyboard instrument 60 wirelessly or by wire.

The configuration and the function of the information processing system 10 are the same as those in the first embodiment. Therefore, the same effects as those of the first embodiment can be realized by the fourth embodiment. Note that configurations according to the second embodiment and the third embodiment can be employed in the electronic keyboard instrument 60 of the fourth embodiment.

### E: Modified Example

Specific modified embodiments to be added to each of the embodiments exemplified above are illustrated below. Two or more embodiments arbitrarily selected from the following examples can be appropriately combined insofar as they are not mutually contradictory.
(1) In each of the embodiments described above, the position estimation section 412 of the input data acquisition unit 41 generates the finger position data X from the image data G, but in an embodiment in which the finger position data X are supplied from an external device, generation of the finger position data X can be omitted. That is, the position estimation section 412 can be omitted form the input data acquisition unit 41.
(2) In each of the embodiments described above, for the sake of convenience, a configuration is shown in which the information processing system 10 comprises both the analysis processing unit 40 and the training processing unit 50, but the analysis processing unit 40 and the training processing unit 50 can be provided in separate systems. The information processing system 10 (performance analysis system) provided with the analysis processing unit 40 analyzes the performance of the electronic instrument 20 by the user. The information processing system 10 (machine learning system) provided with the training processing unit 50 constructs the generative model M (correction model Mb) by machine learning. The performance analysis system is realized by an information device such as a smartphone, a tablet terminal, or a personal computer. The machine learning system is realized by a server device such as a web server. The generative model M constructed by the machine learning system is transmitted to the performance analysis system.
(3) In each of the embodiments described above, a configuration is shown in which the information processing system 10 (analysis processing unit 40) comprises the input data acquisition unit 41, the finger position data generation unit 42, and the analysis data generation unit 43, but one or more of the above-mentioned elements can be omitted.

For example, the input data acquisition unit 41 (input data generation unit) that acquires the input data C1 can function independently without requiring the presence of the finger position data generation unit 42 or the analysis data generation unit 43. That is, the finger position data generation unit 42 and the analysis data generation unit 43 can be omitted from the analysis processing unit 40. Furthermore, an element (for example, the component addition section 413) of the input data acquisition unit 41 that generates the finger position data Y can also stand alone.

Similarly, the finger position data generation unit 42 can function independently without requiring the presence of the input data acquisition unit 41 or the analysis data generation unit 43. That is, the input data acquisition unit 41 and the analysis data generation unit 43 can be omitted from the analysis processing unit 40. Furthermore, an element (for example, the correction processing section 422) of the finger position data generation unit 42 that generates the finger position data Z can also stand alone.
(4) In each of the embodiments described above, a configuration is shown in which the performance of a keyboard instrument (electronic instrument 20) by the user is analyzed, but the musical instrument to be analyzed is not limited to a keyboard instrument. For example, performances of various musical instruments, such as string instruments or wind instruments, are analyzed by the same configuration and process as in each of the embodiments described above. The musical instrument to be analyzed can be either a natural musical instrument or an electronic instrument (or electric instrument). An electronic instrument encompasses, in addition to the electronic keyboard instrument 60 exemplified in the fourth embodiment, electronic string instruments (electric string instruments) and electronic wind instruments (electric wind instruments).
(5) In each of the embodiments described above, a deep neural network is illustrated as an example of the generative model M, but the configuration of the generative model M is not limited to the example described above. For example, statistical models such as a Hidden Markov Model (HMM) or a support vector machine (SVM) can be used as the generative model M.
(6) For example, it is possible to realize the information processing system 10 with a server device that communicates with information devices, such as smartphones or tablet terminals. For example, the information processing system 10 uses the performance data E and the image data G received from the information device to generate analysis data F, and transmits the analysis data F to the information device.
(7) As described above, the functions of the information processing system 10 used as an example above are realized by cooperation between one or more processors that constitute the control device 11, and a program stored in the storage device 12. The program according to the present disclosure can be provided in a form stored in a computer-readable storage medium and installed on a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. In addition, in a configuration in which a distribution device distributes the program via a communication network, a storage medium that stores the program in the distribution device corresponds to the non-transitory storage medium.

### F: Additional Statement

For example, the following configurations can be understood from the embodiments exemplified above.

An information processing method according to one aspect (First Aspect) of this disclosure comprises: acquiring input data including image data representing an image of a hand of a user playing a musical instrument, first finger position data representing the position of each of a plurality of analysis points on the hand, and performance data representing a performance of the musical instrument; and processing the input data using a trained generative model to generate second finger position data in which the position of each of the plurality of analysis points in the first finger position data is corrected in accordance with the position of the hand represented by the image data and the performance represented by the performance data.

In the aspect described above, the position of each of the plurality of analysis points in the first finger position data is corrected in accordance with the position of the hand represented by the image data and the performance represented by the performance data, thereby generating the second finger position data. Accordingly, second finger position data are generated in which the position of each analysis point of the user is represented with higher accuracy than in the first finger position data. That is, it is possible to estimate, with high accuracy, the shape of the user's hand while playing a musical instrument.

A “musical instrument” is any type of instrument that is played by a user using the user's own hands. A typical example of a musical instrument is a keyboard instrument, but string instruments and wind instruments are also included.

“Image data” are data in any format, generated by capturing an image of a user playing a musical instrument. For example, the image data are an image representing the keyboard of a keyboard instrument and both hands (left hand and right hand) of a user. Alternatively, the image data can be an image representing one hand of a user and a musical instrument such as a keyboard instrument, a string instrument and a wind instrument.

An “analysis point” is a point on the user's hand, the location of which is to be analyzed. For example, the tip and joints of each finger of the user are typical examples of analysis points.

The “(first/second) finger position data” are data indicating the position of each analysis point. For example, the finger position data include unit data for each of a plurality of analysis points. The unit data of each analysis point are data indicating the position of said analysis point. Specifically, the data are data representing the probability distribution of the analysis point in space. For example, the unit data are data representing, for each of a plurality of points (for example, lattice points) in space, the probability that said point corresponds to an analysis point.

The “performance data” are data in any format representing the content of a user's performance. A typical example of performance data is MIDI data which specify pitches played by the user. Performance sounds produced from a musical instrument while playing can be analyzed to generate the performance data.

A generative model is a trained model constructed in advance by machine learning. The generative model is constructed such that the position of each of the plurality of analysis points in the first finger position data is corrected in accordance with the position of the hand represented by the image data and the performance represented by the performance data. Specifically, the generative model (correction model) is constructed such that analysis points that are unclear in the image data are supplemented by using the image data and the performance data.

In a specific example (Second Aspect) of First Aspect, the first finger position data include a plurality of pieces of unit data respectively corresponding to the plurality of analysis points, and the unit data corresponding to each of the plurality of analysis points represent the probability distribution of said analysis point in three-dimensional space. In addition, in a specific example (Third Aspect) of First Aspect or Second Aspect, the second finger position data include a plurality of pieces of unit data respectively corresponding to the plurality of analysis points, and the unit data corresponding to each of the plurality of analysis points represent the probability distribution of said analysis point in three-dimensional space. In the aspects described above, the first finger position data or the second finger position data include unit data representing the probability distribution of each analysis point. Accordingly, there is the benefit that the training data to be used for machine learning can be easily generated by adding a prescribed probability distribution to the finger position data of the generative model in the training stage for establishing the generative model.

In a specific example (Fourth Aspect) of Second Aspect or Third Aspect, as a result of the position of each of the plurality of analysis points being corrected, unit data that were null in the first finger position data are changed to unit data including significant numerical values in the second finger position data. According to the aspect described above, even if an analysis point is missing in the first finger position data due to an unclear captured image, said analysis point is supplemented by using the image data and the performance data.

In a specific example (Fifth Aspect) of any one of First to Fourth Aspects, the performance data are event data conforming to the MIDI standard. According to the aspect described above, event data generated by various devices conforming to the MIDI standard can be used as the performance data.

In a specific example (Sixth Aspect) of any one of First to Fifth Aspects, acquisition of the input data include: acquiring the image data and the performance data; generating, from the image data, initial data representing the probability distribution of each of the plurality of analysis points on the hand; and generating the first finger position data from the initial data. In addition, in a specific example of Sixth Aspect: the generative model includes a detection model and a correction model; in the generation of the second finger position data, the image data are processed using the detection model to generate region data representing the region of the hand in the image represented by the image data; in the generation of the first finger position data, when the performance data represent an operation of the musical instrument, or when the hand is detected in the region data, an auxiliary component is added to the initial data to generate the first finger position data; and in the generation of the second finger position data, the first finger position data and the performance data are processed using the correction model to generate the second finger position data.

In a specific example (Seventh Aspect) of Sixth Aspect, the generative model includes a detection model and a correction model. In the generation of the second finger position data, the image data are processed using the detection model to generate region data representing a region of the hand in the image represented by the image data. In the generation of the first finger position data, when the performance data represent an operation of the musical instrument, or when the hand is detected in the region data, an auxiliary component is added to the initial data to generate the first finger position data. In the generation of the second finger position data, the first finger position data and the performance data are processed using the correction model to generate the second finger position data.

In a specific example (Eighth Aspect) of Seventh Aspect, the musical instrument is a keyboard instrument including a keyboard, and when the hand is detected in the region data is when the hand detected in the region data overlaps with the keyboard. In the aspect described above, when the user's hand overlaps with the keyboard, the addition of the auxiliary component to the initial data is executed. That is, not only whether the user's hand is detected but also the relationship between the keyboard and the hand is taken into consideration when adding the auxiliary component. Accordingly, it is possible to estimate, with high accuracy, the shape of the user's hand while playing the keyboard instrument.

In a specific example (Ninth Aspect) of Seventh Aspect or Eighth Aspect, the region data are depth data indicating the depth of the surface of the hand represented by the image data. In the aspect described above, depth data indicating the depth of the surface of the hand represented by the image data are generated as the region data. Accordingly, for example, even if the user's hand is unclear in the image represented by the image data, it is possible to estimate, with high accuracy, the shape of the user's hand while playing the keyboard instrument.

An information processing method according to one aspect (Tenth Aspect) of this disclosure comprises: acquiring image data representing an image of a hand of a user playing a musical instrument, first finger position data representing the position of each of a plurality of analysis points on the hand, and performance data representing the performance of the musical instrument; generating region data representing the region of the hand in an image represented by the image data; processing the first finger position data and the performance data using a correction model to generate second finger position data; and constructing the correction model, wherein, in the acquisition of the image data, the first finger position data, and the performance data: the image and the performance data are acquired; initial data representing the probability distribution of each of the plurality of analysis points on the hand are generated from the image data; and when the performance data represent an operation of the musical instrument, or when the hand is detected in the region data, an auxiliary component is added to the initial data to generate the first finger position data, and in the construction of the correction model: when the performance data represent an operation of the musical instrument, or when the hand is detected in the region data, an auxiliary component is added to the second finger position data to generate the reference data; and the correction model is updated so as to reduce the difference between the first finger position data and the reference data.

In the aspect described above, when the performance data represent an operation of a musical instrument, or when the user's hand is detected in the region data, addition of an auxiliary component to the initial data and addition of an auxiliary component to the second finger position data generated using the correction model are executed, and the provisional correction model is updated so as to reduce the difference between the first finger position data and the reference data. Accordingly, it is possible to generate the second finger position data in which the position of each analysis point in the first finger position data is corrected in accordance with the image data and the performance data. Specifically, even if an analysis point is missing in the image represented by the image data due to an unclear image, said analysis point is supplemented by using the image data and the performance data. That is, a correction model that can appropriately supplement the analysis points is constructed by the training process. Accordingly, it is possible to generate the second finger position data in which analysis points of unclear portions in an image are accurately expressed. The present disclosure is also specified as an information processing system that executes the information processing method of Tenth Aspect, or as a program that causes a computer to execute the information processing method of Tenth Aspect.

In a specific example (Eleventh Aspect) of Tenth Aspect, the musical instrument is a keyboard instrument including a keyboard, and when the hand is detected in the region data is when the hand detected in the region data overlaps with the keyboard. In the aspect described above, when the user's hand overlaps with the keyboard, the addition of the auxiliary component to the initial data and the addition of the auxiliary component to the second finger position data are executed. That is, not only whether the user's hand is detected but also the relationship between the keyboard and the hand is taken into consideration when adding the auxiliary component. Accordingly, it is possible to estimate, with high accuracy, the shape of the user's hand while playing the keyboard instrument.

In a specific example (Twelfth Aspect) of Tenth Aspect or Eleventh Aspect, the region data are depth data indicating the depth of the surface of the hand represented by the image data. In the aspect described above, depth data indicating the depth of the surface of the hand represented by the image data are generated as the region data. Accordingly, for example, even if the user's hand is unclear in the image represented by the image data, it is possible to estimate, with high accuracy, the shape of the user's hand while playing the keyboard instrument.

An information processing system according to one aspect (Thirteenth Aspect) of this disclosure comprises: an input data acquisition unit for acquiring input data including image data representing an image of a hand of a user playing a musical instrument, first finger position data representing the position of each of a plurality of analysis points on the hand, and performance data representing a performance of the musical instrument; and a finger position data generation unit for processing the input data using a trained generative model to generate second finger position data in which the position of each of the plurality of analysis points in the first finger position data is corrected in accordance with the position of the hand represented by the image data and the performance represented by the performance data. Each of the embodiments described above regarding the information processing method according to First Aspect can be similarly applied to the information processing system of Thirteenth Aspect.

A program according to one aspect (Fourteenth Aspect) of this disclosure causes a computer system to function: as an input data acquisition unit for acquiring input data including image data representing an image of a hand of a user playing a musical instrument, first finger position data representing the position of each of a plurality of analysis points on the hand, and performance data representing a performance of the musical instrument; and as a finger position data generation unit for processing the input data using a trained generative model to generate second finger position data in which the position of each of the plurality of analysis points in the first finger position data is corrected in accordance with the position of the hand represented by the image data and the performance represented by the performance data. Each of the embodiments described above regarding the information processing method according to First Aspect can be similarly applied to the program of Fourteenth Aspect.

An electronic keyboard instrument according to one aspect (Fifteenth Aspect) of this disclosure comprises: an input data acquisition unit for acquiring input data including image data representing an image of a hand of a user playing a musical instrument, first finger position data representing the position of each of a plurality of analysis points on the hand, and performance data representing a performance of the musical instrument; and a finger position data generation unit for processing the input data using a trained generative model to generate second finger position data in which the position of each of the plurality of analysis points in the first finger position data is corrected in accordance with the position of the hand represented by the image data and the performance represented by the performance data. Each of the embodiments described above regarding the information processing method according to First Aspect can be similarly applied to the electronic keyboard instrument of Fifteenth Aspect.

What is claimed is:

1. An information processing method realized by a computer system, the method comprising:
acquiring input data including image data representing an image including at least a hand of a user playing a musical instrument, first finger position data representing a position of each of a plurality of analysis points on the hand, and performance data representing a performance of the musical instrument; and
processing the input data using a trained generative model, thereby generating second finger position data in which the position of each of the plurality of analysis points in the first finger position data is corrected in accordance with a position of the hand represented by the image data and the performance represented by the performance data.

2. The information processing method according to claim 1, wherein
the first finger position data include a plurality of pieces of first unit data corresponding to the plurality of analysis points, respectively, and
each of the plurality of pieces of first unit data represents a probability distribution of each of the plurality of analysis points in a three-dimensional space.

3. The information processing method according to claim 2, wherein
the second finger position data include a plurality of pieces of second unit data corresponding to the plurality of analysis points, respectively, and
each of the plurality of pieces of second unit data represents a probability distribution of each of the plurality of analysis points in the three-dimensional space.

4. The information processing method according to claim 3, wherein
the position of each of the plurality of analysis points is corrected such that a piece of the first unit data that is null in the first finger position data is changed to a piece of the second unit data including a numerical value that is not zero in the second finger position data.

5. The information processing method according to claim 1, wherein
the performance data are event data conforming to an MIDI (Musical Instrument Digital Interface) standard.

6. The information processing method according to claim 1, wherein
the acquiring of the input data includes
acquiring the image data and the performance data,
generating, from the image data, initial data representing a probability distribution of each of the plurality of analysis points on the hand, and
generating the first finger position data from the initial data.

7. The information processing method according to claim 6, wherein
the trained generative model includes a detection model and a correction model,
in the generating of the second finger position data, the image data are processed using the detection model to generate region data representing a region of the hand in the image represented by the image data,
the first finger position data are generated by adding an auxiliary component to the initial data, as the performance data represent an operation of the musical instrument, or as the hand is detected in the region data, and
the second finger position data are generated by processing the first finger position data and the performance data using the correction model.

8. The information processing method according to claim 7, wherein
the musical instrument is a keyboard instrument including a keyboard, and
the first finger position data are generated by adding the auxiliary component to the initial data, as the performance data represent an operation of the musical instrument, or as the hand detected in the region data overlaps with the keyboard.

9. The information processing method according to claim 7, wherein
the region data are depth data indicating a depth of a surface of the hand represented by the image data.

10. An information processing method realized by a computer, the method comprising:
acquiring image data representing an image including at least a hand of a user playing a musical instrument, first finger position data representing a position of each of a plurality of analysis points on the hand, and performance data representing a performance of the musical instrument;
generating region data representing a region of the hand in the image represented by the image data;
processing the first finger position data and the performance data using a correction model, thereby generating second finger position data; and
constructing the correction model,
in the acquiring of the image data, the first finger position data, and the performance data,
the image and the performance data being acquired,
initial data representing a probability distribution of each of the plurality of analysis points on the hand being generated from the image data, and
as the performance data represent an operation of the musical instrument, or as the hand is detected in the region data, an auxiliary component being added to the initial data to generate the first finger position data, and
in the constructing of the correction model,
as the performance data represent an operation of the musical instrument, or as the hand is detected in the region data, the auxiliary component being added to the second finger position data to generate a reference data, and
the correction model being updated so as to reduce a difference between the first finger position data and the reference data.

11. The information processing method according to claim 10, wherein
the musical instrument is a keyboard instrument including a keyboard, and
the auxiliary component is added to the initial data to generate the first finger position data, as the performance data represent an operation of the musical instrument, or as the hand detected in the region data overlaps with the keyboard, and
the auxiliary component is added to the second finger position data to generate a reference data as the performance data represent an operation of the musical instrument, or as the hand detected in the region data overlaps with the keyboard.

12. The information processing method according to claim 10, wherein
the region data are depth data indicating a depth of a surface of the hand represented by the image data.

13. An electronic keyboard instrument comprising:
a keyboard including a plurality of keys;
an electronic controller including at least one processor configured to
acquire input data including image data representing an image including at least a hand of a user playing a musical instrument, first finger position data representing a position of each of a plurality of analysis points on the hand, and performance data representing a performance of the musical instrument, and
process the input data using a trained generative model, thereby generating second finger position data in which the position of each of the plurality of analysis points in the first finger position data is corrected in accordance with a position of the hand represented by the image data and the performance represented by the performance data.
